(19) United States
(12) Patent Application Publication
(10) Pub. No.: US 2024/0142386 A1
(43) Pub. Date: May 2, 2024

(54) PROCESSING DEVICE, INSPECTION APPARATUS AND SYSTEM FOR OPTICAL INSPECTION AND CORRESPONDING METHODS

(71) Applicant: LEICA MICROSYSTEMS (SUZHOU) TECHNOLOGY CO., LTD., Suzhou (CN)

(72) Inventors: Linqi JIAO, Suzhou (CN); ChunXin YANG, Suzhou (CN); Fei ZHANG, Suzhou (CN); YuanPing ZHOU, Suzhou (CN); Minquan LI, Suzhou (CN); Wei ZHAO, Suzhou (CN); Shengwei FENG, Suzhou (CN)

(21) Appl. No.: 18/279,079

(22) PCT Filed: Mar. 1, 2021
(86) PCT No.: PCT/CN2021/078528

§ 371 Date: Aug. 28, 2023

(51) Int. Cl. G01N 21/88

(52) U.S. Cl. CPC G01N 21/88

(57) ABSTRACT

A processing device to be used in an inspection apparatus for optical inspection of samples is configured to be used with an optical inspection device, to be communicatively coupled to a user interface, to receive input data from the user interface and/or from the optical inspection device, and to provide output data to the user interface, and to be communicatively coupled to at least one other processing device to allow data transfer. The processing device is configured as a master unit, and the at least one other processing device is configured as a slave unit. The processing device is further configured to provide a data storage for storing data received as input and/or to be provided as output, and to allow the at least one other processing device to access the data storage to store data and/or to retrieve data.

### CROSS REFERENCE TO RELATED APPLICATIONS

This application is a U.S. National Phase application under 35 U.S.C. § 371 of International Application No. PCT/CN2021/078528, filed on Mar. 1, 2021. The International Application was published in English on Sep. 9, 2022 as WO 2022/183338 A1 under PCT Article 21(2).

### FIELD

Embodiments of the present invention relate to a processing device to be used in an inspection apparatus for optical inspection of samples, to such an inspection apparatus, to a system comprising several of such inspection apparatuses and to methods for providing optical inspection of samples for several users and for operating such a processing device

### BACKGROUND

Optical inspection of subjects or samples is applied in different technical fields. For example, in medical technology, components like stents have to be checked for specific quality requirements before their final use. Such quality inspection might be performed by eye or by using magnifying instruments like microscopes. Any results of the inspections like pass or fail can be noted by hand or, e.g., in simple digital sheets.

### SUMMARY

Embodiments of the present invention provide a processing device to be used in an inspection apparatus for optical inspection of samples, the processing device being configured to be used with an optical inspection device, to be communicatively coupled to a user interface, to receive input data from the user interface and/or from the optical inspection device, and to provide output data to the user interface, and to be communicatively coupled to at least one other processing device to allow data transfer. The at least one other processing device is configured to be used with a respective optical inspection device, to be communicatively coupled to a respective user interface, to receive input data from the respective user interface and/or from the respective optical inspection device, and to provide output data to the respective user interface. The processing device is configured as a master unit, and the at least one other processing device is configured as a slave unit. The processing device is further configured to provide a data storage for storing data received as input and/or to be provided as output, and to allow the at least one other processing device to access the data storage to store data received as input at the at least one other processing device and/or to retrieve data to be provided as output data to the respective user interface at the at least one other processing device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic overview of an inspection apparatus according to some embodiments;

FIG. 2 shows a detailed view of a processing device being part of the inspection apparatus of FIG. 1 according to some embodiments;

FIG. 3 shows a schematic overview of a system for optical inspection according to some embodiments; and

FIG. 4 shows, schematically, a flowchart describing a method according to some embodiments.

### DETAILED DESCRIPTION

Embodiments of the present invention provide a processing device, an inspection apparatus, a system with several inspection apparatuses, a method to provide optical inspection for several users, a method for operating a processing device and a corresponding computer program.

Embodiments of the present invention relate to inspection apparatuses for optical inspections (in particular optical quality inspection) of samples, processing devices to be used with or in such apparatuses, and in particular, to systems comprising several of such apparatuses. In particular, such samples can comprise medical components or parts like stents, medical screws and the like. However, also different kinds of samples might be inspected, of course. Such inspection apparatus comprises optical inspection means (or an optical inspection device), user interface means or devices, and a processing device. The optical inspection means preferably comprise a camera (i.e. an image acquisition means) and, in particular, also a microscope a user can use for detailed inspection and magnification of a sample. The user interface means preferably comprise display means like a monitor (display) and also user input means or devices like a keyboard and/or a computer mouse. Also, the user interface means can comprise a touch display which is a display means and user input means in combination.

The camera can be combined with the microscope and also with the user interface means or at least part of it. For example, the camera can be attached to the microscope to allow (live) imaging of the sample via the microscope.

The processing device is a computing unit that is communicatively coupled to the user interface means and also to the camera if used. This allows receiving input data from the user interface means and/or from the optical inspection means (in particular from the camera), and providing output data to the user interface means. In this way, operation can be controlled by the processing device. Note that the processing device can comprise individual communication interfaces for connecting each of the respective components; however, also several components can be connected to a common interface of the processing device. For example, individual USB interfaces can be provided for the camera, for a keyboard and for a computer mouse (keyboard and computer mouse can, of course, also be connected to a common USB interface). A HDMI interface can be provided for a display.

Further, storage means are provided on which data like instructions for a user to be performed for quality inspections can be stored. Also, data acquired during such quality inspection (quality report data) can be stored thereon. Such storage means can also be connected or communicatively coupled to the processing device, e.g., via an interface. In general, different kinds of storage means can be used, as will be explained later.

The processing device can then be configured to access the storage means and the instruction data stored thereon in order to provide instructions to a user and to be performed by a user for quality control. Such instructions are to be transmitted to the display means to be displayed to the user currently viewing (or inspecting) a sample.

In order to facilitate inspection of several samples at the same time, several of these inspection apparatuses can be used for several users or operators, one apparatus to be used by one user. The inspection apparatuses can be coupled via the respective processing devices, i.e., each processing device is configured to be communicatively coupled to other processing devices. Each processing device can comprise a communication interface like an Ethernet interface for connection within a network like (local) Ethernet network or over internet. Such connection of several processing devices (or inspection apparatuses) requires handling of relevant data (e.g., instruction data or quality report data as mentioned above).

Providing each processing device (or inspection apparatus) with individual storage means would require a couple of storage means, each having instruction data and quality report data stored thereon. This is cost intensive and difficult to handle. Thus, single and common storage means can be provided for all of the several processing devices.

A server running a database might be connected or communicatively coupled to the several processing devices, e.g., via network. Such database, in general, allows management and storage of many data files. For this purpose, data service software can be installed in a customer's network. This software communicates with database of, e.g., a costumer. Designer software can be provided to a manager who creates the instructions for the quality inspection or quality control and respective workflow with, for example, detailed steps, golden images, reference images and acceptance criteria. The conducted workflow (instructions in instruction data) can be saved in the database and deployed to the users or operators via the data service software.

The operator software can be provided to the operators to execute the instructions or workflow created by the manager. The workflow also may automatically upgrade if there is a new version updated by the manager. The quality report data (or quality control, QC, data) operators capture during the workflow execution can be saved to the database in real time. The manager can view the completed QC report via designer software in real time as well; furthermore, the manager can approve and/or reject the report. As the data is saved in the database, a customer can do further data analysis by themselves.

Another possibility is to allow all processing devices access to a simple storage means. According to some embodiments, one of the several processing devices is configured as a master unit in case (or if) the other (remaining ones of the) processing devices are configured as slave units. In other words, the chosen processing device is configured as a master unit and the other processing devices are configured as slave units. Further, the master unit is configured to provide a data storage for data received as input and/or to be provided as output, and to allow each of the other processing devices (the slave units), when coupled to the master unit, to access the data storage to store data received as input at the respective other processing device and/or to retrieve data to be provided as output to the user interface means at the respective processing device. In other words, the master unit handles a storage means connected to the master unit and provides access to it for all other processing devices. The data storage provided in this way is, in particular, be provided as a folder based storage (with file system).

In comparison to the database solution, such solution with simple storage means like the folder based solution does not require to provide a database (with server) by, e.g., the customer). Instead, one of the processing devices is used as the master (and, thus, plays the same role as the database). Other processing devices are running in slave mode which connect and save the QC data to the master and the data storage provided by the master. While such processing device, in general, can comprises storage means or storage space, there is no need for that (large amounts of data space would be required). Thus, external storage means (or device) can be connected to the master unit. Such storage means can be, for example, network folders, U disk (hard disk drive in form of a (large) USB stick), hard disk drives, solid state disks and the like. In this way, the external storage means, when coupled, are provided as the data storage for data received as input and/or to be provided as output.

While one of the several processing devices is configured as the master and all other as slaves, each of the processing devices is, preferably, adapted to be alternatively configured as a master unit or as a slave unit. Thus, any one out of the several processing devices can be chosen to be configured as the master. This, for example, could require installing appropriate software to allow acting as a master (and allowing the access to the data storage).

Preferably, both kinds of storage are combined, i.e., one processing devices is configured as the master unit and provides access to the data storage for the slave units (and also to the master unit itself, of course), and a database (e.g., on a server) is provided in addition. This allows storing different kind of data on different storages. For example, large data files like images can be stored on the data storage (storage means connected to the master) and quality report data, for example, can be stored on the database. Also, instruction data can be stored on the database or on the storage means, depending on the requirements.

Embodiments of the present invention also relate to a method to provide optical inspection for several users, a method for operating a processing device and a corresponding computer program with program code. In order to avoid any repetition with respect to advantages and further preferred embodiments, it is referred to the remarks for the processing device, apparatus and system above, which apply here correspondingly.

In addition, it is to be noted that each of the processing devices can be configured such that it allows performing some or all of the tasks provided by the integrated processing means of the camera (kind of smart or intelligent camera) disclosed in document WO 2020/182088 A1, which refers to a digital microscope camera and a microscope with such a camera that allows imaging samples. In contrast to such smart camera, the processing device according to embodiments of the present invention, is a device provided separately from the camera and, thus, can be used in combination with different cameras as per the user's or costumer's needs.

Further advantages and embodiments of the invention will become apparent from the description and the appended figures.

It should be noted that the previously mentioned features and the features to be further described in the following are usable not only in the respectively indicated combination, but also in further combinations or taken alone, without departing from the scope of the present invention.

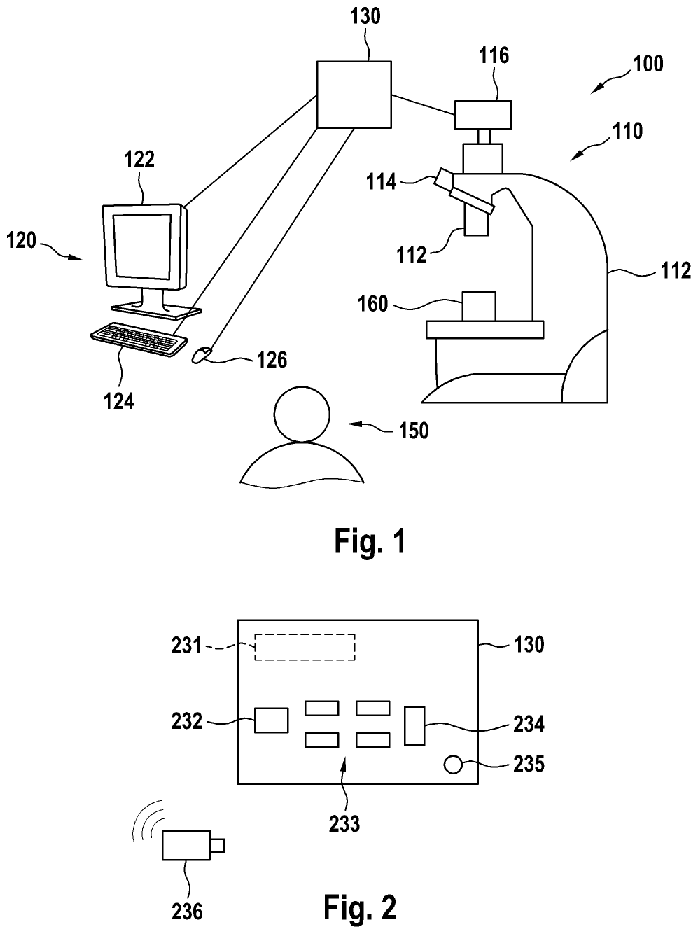

FIG. 1 illustrates a schematic overview of an inspection apparatus 100 according to an embodiment of the invention. The inspection apparatus 100 comprises optical inspection means 110, user interface means 120, and a processing device 130. The optical inspection means 110 comprise a microscope 112, having an objective 112 and an eyepiece 114, and a camera 116. By means of example, the camera 116 is coupled to the microscope 112 separately from the eyepiece 114 such that a user or operate 150 can view or optically inspect a sample 160 via the eyepiece 114 and, at the same time, a live image of the sample 160 can be acquired by the camera 116. The camera 116 is communicatively coupled to the processing device 130. The processing device 130 might be mounted to the microscope by means of a mounting bracket, if required.

The user interface means 120 comprise display means 122, in the form of a monitor or display, and a keyboard 124 and a computer mouse 126 as input means. Each of these components means 122, keyboard 124 and a computer mouse 126, is connected (communicatively coupled) to the processing device 130. Thus, a user can view or optically inspect the sample also via the display means. Also, the separate eyepiece can be omitted.

FIG. 2 illustrates a more detailed view of the processing device 130 of FIG. 1, in particular a rear view. The processing device 130 comprises a processor (CPU) 231 and several (communication) interfaces or ports. By means of example, these interfaces comprise an Ethernet interface 232, four USB interfaces 233 (these might be of different kind, e.g., USB 3.0 and/or USB 2.0), and a HDMI interface 234. Further, a power supply socket 235 is provided. The Ethernet interface 232 can be used to connect the processing device 130 to a network (see also following remarks), USB interfaces 232 can be used to connect the processing device 130 to the camera 116, the keyboard 124 and the computer mouse 126. The HDMI interface 234 can be used to connect the processing device 130 to the display means 122. In addition, a WIFI dongle 236 is illustrated which can be connected to one of the USB interfaces 233 in order to provide another network connection. Further components like a barcode scanner and/or a footswitch (which can be considered a user interface means) may be connected, if required. Also, further (mobile) storage devices may be connected. Note that these interfaces and their use for connections are only for illustration purposes.

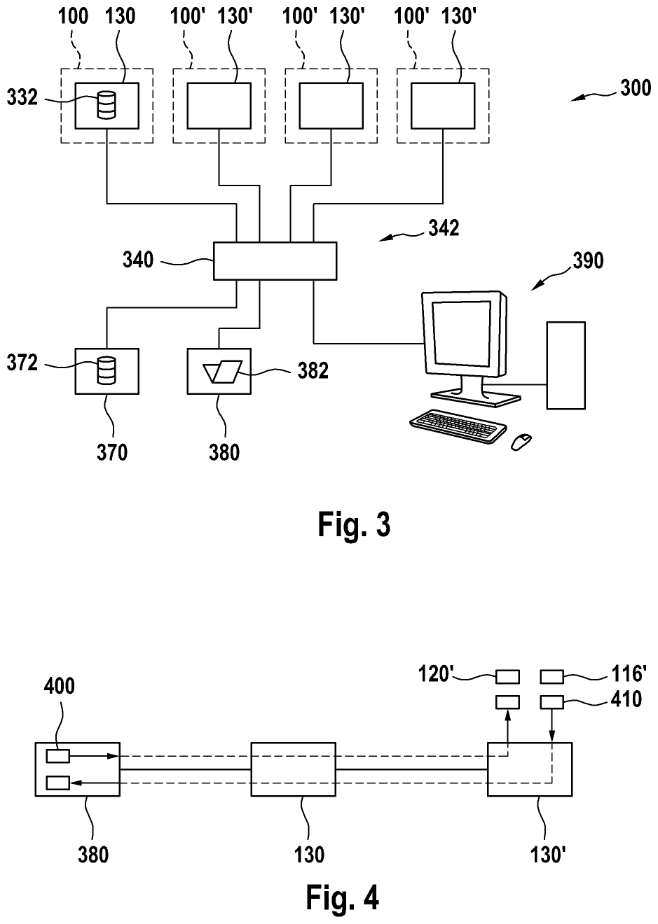

FIG. 3 illustrates a schematic overview of a system 300 for optical inspection according to an embodiment of the invention. The system 300 comprises several inspection apparatuses like the inspection apparatus 100 shown in FIG. 1. The inspection apparatus 100 of FIG. 1 is illustrated only by a rectangle including the processing device 130. For further details, it is referred to FIGS. 1 and 2 and the corresponding description. Three further inspection apparatuses 100′ with processing devices 130′ are illustrated in the same way. Each of the inspection apparatuses 100′ and the respective processing devices 130′ corresponds, in particular, the inspection apparatus 100 and the processing device 130 with the only difference that processing device 130 is configured as a master unit while the other processing devices 120′ are configured as slave units as will be explained in further detail below.

Each of the processing devices 100, 100′ is connected (communicatively coupled) to an Ethernet switch 340, using, e.g., the respective Ethernet interface (see FIG. 2), such that each of the processing devices is integrated into a network 340. In addition, a server 370, an external storage means 380 and a computer 390 are also connected to the network switch 340 and, thus, to the network 342. The server 370 with the database 372 is optional as will be described later. Note that the network structure shown is just an example and might differ in realty. For example, further switches might be used and, in particular, some components or devices might also be connected over Internet.

As mentioned before, the processing device 130 in system 300 is configured as a master unit while the other processing devices 130 are used or configured as slave units. Note that each of the processing devices 130, 130′ might—in general—be chosen to be configured as the master unit. This might require installing software on the chosen processing device. The master unit 130 is configured to provide a data storage 332 for the slave units 130′ on the storage means 380. In particular, this data storage is provided in form of a folder based storage (having a file system). As mentioned above, the storage means can be a network folder, hard disk drive or solid state disk.

Further, different software applications (apps) may be provided on the master unit or an each of the processing devices, for example, a manager app for a manager to define different workflows and the like and an operator app for a user to perform the optical quality inspection.

FIG. 4 illustrates, schematically, part of the system 300 of FIG. 3 and a flow scheme, describing a method according to an embodiment of the invention. In particular, processing device 130, the master unit, one processing device 130′, a slave unit, and the storage means 380 are shown. As mentioned above, the master unit 130 is configured to provide a data storage (on the storage means 380) for data received as input and/or to be provided as output. Also, the master unit 130 is configured to allow each of the slave units to access the data storage to store data which was received as input at the respective salve unit, and to retrieve data from the data storage to be provided as output to the user interface means at the respective slave unit.

In FIG. 4, data 400 is stored on the storage means 380 and includes, for example, instruction data for instructions to be displayed at the display means 120′ connected to the slave unit 130′. Data 400 is thus output data. The slave unit 130′ has or is granted access to the storage means 380 and, thus, to data 400 via the master unit 130. This allows presenting, for example, instructions for optical quality inspection of a sample at the user interface means 120′ (or the display means comprised) for a user.

Further, data 410 can be generated at the user interface means 120′ (e.g., by input to the keyboard, such data can comprise a quality report) and/or from the camera 116′ (which is part of the optical inspection means). In the latter case, the data comprises image data. Such input data 410 is to be stored in the storage means 380. The slave unit 130′ has or is granted access to the storage means 380 and, thus, can store data 410 via the master unit 130.

Note that all other slave units can also access the storage means 380 via the master unit 130 in the same way. Of course, the master unit itself has access to the storage means 380 in order to store data received from the user interface means and/or camera assigned to the master unit and to retrieve data to be presented at these user interface means.

As mentioned above, the database 372 provided on the server 370 can optionally be used. Such database 372 can be based on, for example, MariaDB 10.4 or 10.5, MySQL 8 or SQLlite 3. Access to the database 372 is available for each of the processing devices 130, 130′ directly, irrespective of whether it is configured as master or slave unit. Then, different kind of data can be stored on these different storages. For example, large data files like images (preferably acquired as input data by the camera as mentioned above) can be stored on the data storage 380 and quality report data, for example, can be stored on the database 372. Also data like user profiles, workflows (instruction data), QC data, (QC) reports, audit trail, can be stored on the database. Note that in embodiments without database, all data is stored on the external storage (or folder based storage).

Besides, back-ups of operating systems of the processing devices can be stored on the external storage device and/or the server for the database.

In addition, the computer 390 (see FIG. 3) can be run with designer software (i.e., software used to defined or create specific data or workflows by a manager or the like). Such designer software may be used for user management, workflow management, builder and UI designer, report management, data management, Q-matrix (matrix defining quality inspections/reports) and measuring device management. Depending on the configuration and storage to be used, computer 390 accesses the database (directly) or the external storage device via the master unit (similar to the access granted to a slave unit).

As mentioned above, the server with the database can, in general, be used instead of or without the external storage means (and thus without a master and slave configuration). In this case, the database can store user profiles, workflows (instruction data), QC data, (QC) reports, audit trail, and also images (or image data). In this case, the computer 390 accesses the database only.

As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Some embodiments relate to a microscope comprising a system as described in connection with one or more of the FIGS. 1 to 4. Alternatively, a microscope may be part of or connected to a system as described in connection with one or more of the FIGS. 1 to 4. FIG. 1 shows a schematic illustration of an inspection apparatus 100 (system) configured to perform a method described herein. The inspection apparatus 100 comprises a microscope 112 and a computer system 130 (processing device). The microscope 112 or inspection means 110 is configured to take images and is connected to the computer system 130. The computer system 130 is configured to execute at least a part of a method described herein. The computer system 130 may be configured to execute a machine learning algorithm. The computer system 130 and microscope 112 may be separate entities but can also be integrated together in one common housing. The computer system 130 may be part of a central processing system of the microscope 112 and/or the computer system 130 may be part of a subcomponent of the microscope 112, such as a sensor, an actor, a camera or an illumination unit, etc. of the microscope 112.

The computer system 130 may be a local computer device (e.g. personal computer, laptop, tablet computer or mobile phone) with one or more processors and one or more storage devices or may be a distributed computer system (e.g. a cloud computing system with one or more processors and one or more storage devices distributed at various locations, for example, at a local client and/or one or more remote server farms and/or data centers). The computer system 130 may comprise any circuit or combination of circuits. In one embodiment, the computer system 130 may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), for example, of a microscope or a microscope component (e.g. camera) or any other type of processor or processing circuit. Other types of circuits that may be included in the computer system 130 may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems. The computer system 130 may include one or more storage devices, which may include one or more memory elements suitable to the particular application, such as a main memory in the form of random access memory (RAM), one or more hard drives, and/or one or more drives that handle removable media such as compact disks (CD), flash memory cards, digital video disk (DVD), and the like. The computer system 130 may also include a display device, one or more speakers, and a keyboard and/or controller, which can include a mouse, trackball, touch screen, voice-recognition device, or any other device that permits a system user to input information into and receive information from the computer system 130.

Some or all of the method steps may be executed by (or using) a hardware apparatus, like for example, a processor, a microprocessor, a programmable computer or an electronic circuit. In some embodiments, some one or more of the method steps may be executed by such an apparatus.

Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments of the invention comprise a data carrier having electronically readable control signals, which are capable of cooperating with a programmable computer system, such that one of the methods described herein is performed.

Embodiments of the present invention can be implemented as a computer program product with a program code, the program code being operative for performing one of the methods when the computer program product runs on a computer. The program code may, for example, be stored on a machine readable carrier.

Other embodiments comprise the computer program for performing one of the methods described herein, stored on a machine readable carrier.

In other words, an embodiment of the present invention is, therefore, a computer program having a program code for performing one of the methods described herein, when the computer program runs on a computer.

A further embodiment of the present invention is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitionary. A further embodiment of the present invention is an apparatus as described herein comprising a processor and the storage medium.

A further embodiment of the invention is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment of the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A processing device to be used in an inspection apparatus for optical inspection of samples, the processing device being comprising the capability:
to be used with an optical inspection device,
to be communicatively coupled to a user interface,
to receive input data from the user interface and/or from the optical inspection device, and
to provide output data to the user interface, and
to be communicatively coupled to at least one other processing device to allow data transfer, each of the at least one other processing device being configured to be used with a respective optical inspection device, to be communicatively coupled to a respective user interface, to receive input data from the respective user interface and/or from the respective optical inspection device, and to provide output data to the respective user interface,
wherein the processing device is configured as a master unit, and the at least one other processing device is configured as a slave unit,
the processing device is further configured:
to provide a data storage for storing data received as input and/or to be provided as output, and
to allow the at least one other processing device to access the data storage to store data received as input at the at least one other processing device and/or to retrieve data to be provided as output data to the respective user interface at the at least one other processing device.

2. The processing device of claim 1, being configured to be communicatively coupled to an external storage device, and to provide the external storage device as the data storage.

3. The processing device of claim 1, wherein the data storage is configured as a folder based storage.

4. The processing device of claim 1, being adapted to be alternatively configured as a master unit or as a slave unit.

5. The processing device of claim 1, being configured to provide instructions for optical inspections via the user interface, wherein the instructions include data to be provided as output, and/or instructions to generate data as input.

6. An inspection apparatus for optical inspection of a sample, the inspection apparatus comprising:
an optical inspection device,
a user interface, and
the processing device of claim 1 communicatively coupled to the user interface.

7. A system for optical inspection of samples for a plurality of users, the system comprising:
a plurality of inspection apparatuses,
wherein each inspection apparatus comprises:
an optical inspection device,
a user interface, and
a processing device communicatively coupled to the user interface,
wherein the processing device is configured to receive input data from the user interface and/or from the optical inspection device, and to provide output data to the user interface means,
wherein the processing devices of the plurality of inspection apparatuses are communicatively coupled to each other to allow data transfer,
wherein one of the processing devices is the processing device of claim 1, and is configured as a master unit and the remaining ones of the processing devices are configured as slave units,
wherein each of the slave units is configured to access the data storage provided by the master unit to store data received as input via the user interface at the respective slave unit, and/or to store data received as input from the optical inspection device at the respective slave unit, and/or to retrieve data to be provided as output to the user interface at the respective slave unit.

8. The system of claim 7, wherein the master unit comprises an external storage communicatively coupled to the master unit.

9. The system of claim 7, wherein each of the processing devices is adapted to be alternatively configured as a master unit or as a slave unit.

10. The system of claim 7, further comprising a database, provided on a server communicatively coupled to the processing devices, the database providing storage for data received as input and/or to be provided as output at each of the processing devices.

11. The system of claim 10, configured to use the data storage provided by the master unit for at least one kind of data, and to use the database as storage for at least one other kind of data.

12. The system of claim 7, wherein each of the processing devices is configured to provide instructions for optical inspections via the respective user interface, wherein the instructions include data to be provided as output, and/or include instructions to generate data as input.

13. The system of claim 7, wherein each of the optical inspection devices comprising a microscope and a camera communicatively coupled to the respective processing device, and/or each of the user interfaces comprises a display and an input device.

14. A method to provide optical inspection of samples for a plurality of users, the method comprising:
providing a plurality of inspection apparatuses,
wherein each inspection apparatus comprises: an optical inspection device, a user interface, and a processing device that is communicatively coupled to the user interface, wherein the processing device is configured to receive input data from the user interface and/or from the optical inspection device, and to provide output data to the user interface,
coupling the plurality of processing devices of the plurality of inspection apparatuses, communicatively to each other to allow data transfer,
configuring one of the plurality of processing devices, as a master unit and remaining ones of the plurality of processing devices as slave units,
configuring the master unit to provide a data storage for data received as input and/or to be provided as output, and
configuring each of the slave units, to access the data storage provided by the master unit to store data received as input from the user interface at the respective slave unit and/or from the optical inspection device at the respective slave unit, and/or to retrieve data to be provided as output to the user interface at the respective slave unit.

15. A method for operating a processing device to be used in an inspection apparatus for optical inspection of samples, the processing device being configured to be used with an optical inspection device, to be communicatively coupled to a user interface, to receive input from the user interface and/or from the optical inspection device, and to provide output to a user via the user interface,
wherein the processing device is configured to be communicatively coupled to at least one other processing device to allow data transfer, the at least one other processing device being configured to be used with a respective optical inspection device, to be communicatively coupled to a respective user interface, to receive input from the respective user interface and/or from the respective optical inspection device, and to provide output to the respective user interface,
wherein the processing device is configured as a master unit and the at least one other processing is configured as a slave unit,
the method comprising:
providing, at the processing device, a data storage for data received as input and/or to be provided as output, and
allowing, by the processing device, the at last one other processing device to access the data storage to store data received as input via the user interface and/or the optical inspection device, at the at least one other processing device and/or to retrieve data to be provided as output to the user interface at the at least one other processing device.

16. A non-transitory computer-readable medium having program steps stored thereon, the program steps, when executed by the processing device, facilitating performance of the method of claim 15.
